(19) United States
(12) Patent Application Publication
(10) Pub. No.: US 2023/0228528 A1
(43) Pub. Date: Jul. 20, 2023

(54) MANAGING FLIGHT FORMATION OF MUNITIONS

(71) Applicant: Rosemount Aerospace Inc., Burnsville, MN (US)

(72) Inventors: Guy Squillace, Prior Lake, MN (US); Gary Willenbring, Waconia, MN (US); Todd A. Ell, Savage, MN (US)

(73) Assignee: Rosemount Aerospace Inc., Burnsville, MN (US)

(21) Appl. No.: 17/578,190

(22) Filed: Jan. 18, 2022

(51) Int. Cl. F41G 7/22

(52) U.S. Cl. CPC F41G 7/226; F41G 7/2213; F41G 7/2206

(57) ABSTRACT

A method including obtaining at each of a plurality of nodes navigation data of the node, communicating at each node its navigation data to the other nodes via each node's datalink communication system, receiving at each node navigation data communicated from the other nodes, determining at each node distance range of the node relative to the other nodes for which navigation data was received, determining at each node a constellation of the nodes as a function of the navigation data of the node, the navigation data received from the other nodes, and the distance range of the node relative to the other nodes, accessing formation constraints to form the constellation at each node, calculating at each node first guidance commands to maneuver the node to adjust the constellation to be in compliance with the formation constraints; and navigating each node to execute a maneuver based on the first guidance commands.

### FIELD OF THE DISCLOSURE

The disclosed embodiments generally relate to munitions, and more particularly, to managing flight formation of munitions while in motion.

### BACKGROUND

When engaging one or more targets (e.g., ground targets), a salvo of multiple munitions can be used in a coordinated strike of the target(s). The salvo is often maneuverable and autonomous in flight. When individual munitions in the salvo are provided with a datalink, they are able to share positioning and targeting data for a coordinated engagement. Global positioning system (GPS) data may be used and shared to coordinate the munitions for reaching the target location and avoiding interference with flight paths of other munitions to avoid collision and loss of one or more munitions.

It is to be appreciated that the usage of GPS is not always practical or available. For example, GPS signals can be jammed or spoofed. Shorter range munitions may not incorporate a GPS device due to size or cost constraints. Without GPS, munitions would depend on an inertial measurement unit (IMU) to determine a navigation solution to use in guidance. Biases in the IMU may cause the navigation solution to drift, causing the munition to drift. If a munition drifts too far off course, it may fall out of range of the data link and/or become poorly positioned to engage the target in coordination with its salvo.

When a salvo is centralized, such as by providing control via a designated node, there is reliance on that node. There is risk that this node could fail or be compromised due to interferance, which would disrupt or destroy the ability to maintain a flight formation.

When one node is enhanced, such as for providing centralized control of the salvo, this can add expense, complexity, and consume an increased data bandwidth. A centralized node needs to collect position and ranging data from the other nodes, send formation information, and send commands. Distributed processing only needs to send the position and ranging data.

Thus, it is desirable to provide distributed autonomous control of a salvo that uses IMU and compensates for biases and/or drift.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, disclosed is a method for coordination of a plurality of nodes for travelling in a constellation mission, wherein each node is provided with a datalink communication system to communicate with other nodes. The method includes obtaining at each node navigation data of the node, communicating at each node the navigation data of the node to the other nodes of the plurality of nodes via each node's datalink communication system, receiving at each node navigation data communicated from the other nodes via each node's datalink communication system, determining at each node distance range of the node relative to the other nodes for which navigation data was received, determining at each node a constellation of the plurality of nodes as a function of the navigation data of the node, the navigation data received from the other nodes, and the distance range of the node relative to the other nodes, accessing formation constraints at each node, wherein the formation constraints are configured to form the constellation, calculating at each node first guidance commands to maneuver the node to adjust the constellation determined by the node to be in compliance with the formation constraints, and navigating each node to execute a maneuver based on the first guidance commands.

In one or more embodiments, the method can further include calculating at each node spring forces applied to the node, and determining whether the constellation determined by the node is in compliance with the formation constraints, wherein the constellation is caused to be in compliance with the formation constraints by optimizing the spring forces applied to the node to be at equilibrium.

In one or more embodiments, the method can further include calculating at each node second guidance commands to maneuver the node along a flight path based on a predetermined flight plan or target destination and the navigation data of the node, and combining the first and second guidance commands. Navigating the node can be based on the combination of the first and second guidance commands.

In one or more embodiments, the method can further include tracking a target at each node, calculating at the node second guidance commands to maneuver the node along a fight path to a target based on the tracking, and combining the first and second guidance commands. Navigating the node can be based on the combination of the first and second guidance commands.

In one or more embodiments, wherein the plurality of nodes can be a plurality of munitions in a salvo discharged to attack one or more targets.

In one or more embodiments, one or more of the nodes can be denied access to a Global Positioning System (GPS).

In one or more embodiments, the method can further include receiving at each node inertial measurement data, and estimating at each node the navigation data for the node from the inertial measurement data received at the node, wherein the navigation data includes position, velocity, and attitude.

In one or more embodiments, each node can be preloaded with at least one of a flight plan to a target destination, the formation constraints, and a formation of the constellation.

In one or more embodiments, each munition in the salvo can be selected from the group consisting of: gun launched munitions; rocket propelled munitions; motor propelled munitions; air dropped munitions; and Unmanned Aerial Vehicles.

In one or more embodiments, the method can further include, when the constellation is determined by the node to not be in compliance with the formation constraints, ignoring nodes that are determined to be outliers or unreliable.

In a further aspect of the disclosure, a navigation system for providing coordination of a plurality of nodes for travelling in a constellation mission is provided. The navigation system of each node includes a datalink communication system configured and operable to communicate with other nodes of the plurality of nodes, a navigation component for navigating the node in travel, wherein the navigation system is communicatively coupled to the datalink communication system. The navigation system further includes a memory configured to store instructions and a processor disposed in communication with the memory. The processor upon execution of the instructions is configured to obtain navigation data of the node, communicate the navigation data of the node to the other nodes of the plurality of nodes via the node's datalink communication system, receive navigation data communicated from the other nodes via the other nodes' datalink communication systems, determine a distance range of the node relative to the other nodes for which navigation data was received, determine a constellation of the plurality of nodes as a function of the navigation data of the node, the navigation data received from the other nodes, and the distance range of the node relative to the other nodes, access formation constraints, wherein the formation constraints are configured to form the constellation, calculate first guidance commands to maneuver the node to adjust the constellation determined by the node to be in compliance with the formation constraints, and navigate the node to execute a maneuver based on the first guidance commands.

In one or more embodiments, the processor, upon execution of the instructions, can be further configured to calculate spring forces applied to the node and determine whether the constellation determined by the node is in compliance with the formation constraints, wherein the constellation is caused to be in compliance with the formation constraints by optimizing the spring forces applied to the node to be at equilibrium.

In one or more embodiments, the processor, upon execution of the instructions, can be further configured to calculate second guidance commands to maneuver the node along a flight path based on a predetermined flight plan or target destination and the navigation data of the node, and combine the first and second guidance commands, wherein navigating the node is based on the combination of the first and second guidance commands.

In one or more embodiments, the processor, upon execution of the instructions, can be further configured to track a target , calculate at the node second guidance commands to maneuver the node along a fight path to a target based on the tracking, and combine the first and second guidance commands. Navigating the node can be based on the combination of the first and second guidance commands.

In one or more embodiments, the plurality of nodes can be a plurality of munitions in a salvo discharged to attack one or more targets.

In one or more embodiments, one or more of the nodes can be denied access to a Global Positioning System (GPS).

In one or more embodiments, the navigation data can include position, velocity, and attitude, which can be estimated from inertial measurement data of the node and of the other nodes.

In one or more embodiments, the memory is preloaded with at least one of a flight plan to a target destination, the formation constraints, and a formation of the constellation.

In one or more embodiments, the processor, each munition in the salvo can be selected from the group consisting of: gun launched munitions; rocket propelled munitions; motor propelled munitions; air dropped munitions; and Unmanned Aerial Vehicles.

In one or more embodiments, the processor, upon execution of the instructions, can be further configured to, when the constellation is determined by the node to not be in compliance with the formation constraints, ignore nodes that are determined to be outliers or unreliable.

### BRIEF DESCRIPTION OF THE DRAWINGS

So that those skilled in the art to which the subject disclosure appertains will readily understand how to make and use the devices and methods of the subject disclosure without undue experimentation, various illustrated embodiments thereof will be described in detail herein below with reference to certain figures, wherein:

FIG. 1 illustrates a schematic diagram of an example munition projectile, in accordance with one or more embodiments of the disclosure;

FIG. 2 illustrates a block flow diagram of an example navigation system utilized in a munition, in accordance with one or more embodiments of the disclosure;

FIG. 3 illustrates a block flow diagram of an example navigation system utilized in a munition, in accordance with another embodiment of the disclosure;

FIG. 4A illustrates monitions of a salvo communicating for maneuvering into a constellation based on format constraints, in accordance with one or more embodiments of the disclosure;

FIG. 4B illustrates a salvo of munitions maneuvering to travel along a flight path while staying in a constellation based on the formation constraints, in accordance with one or more embodiments of the disclosure;

FIG. 5 illustrates a salvo of munitions using theoretical spring forces to maneuver the munitions to comply with the formation constraints; and

FIG. 6 is flowchart of an exemplary process for constraining drift of a munition in accordance with the illustrated embodiments.

### DETAILED DESCRIPTION OF CERTAIN EMBODIMENTS

Aspects of the disclosure are disclosed in the following description and related drawings directed to specific illustrated embodiments. Alternate embodiments may be devised without departing from the scope of the illustrated. Additionally, well-known elements of the illustrated embodiments will not be described in detail or will be omitted so as not to obscure the relevant details of the illustrated embodiments.

The word “exemplary” is used herein to mean “serving as an example, instance, or illustration.” Any embodiment described herein as “exemplary” is not necessarily to be construed as preferred or advantageous over other embodiments Likewise, the term “embodiments of the disclosure” does not require that all illustrated embodiments include the discussed feature, advantage or mode of operation.

The terminology used herein is for the purpose of describing particular embodiments only and is not intended to be limiting of the illustrated embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the illustrated embodiments may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A plurality of nodes travelling in a constellation are provided. Each of the nodes accesses formation constraints that are configured to form the constellation. The nodes each calculate guidance commands to maneuver the node to adjust the constellation so that it is in compliance with the formation constraints, such as by calculating theoretical spring forces. The nodes each determine navigational maneuvers that will change the node's position relative to the other nodes and cause the constellation to be in compliance with the formation constraints by adjusting the spring forces applied to the node to optimally achieve equilibrium as defined by the formation constraints. The nodes execute maneuvers based on the first guidance commands.

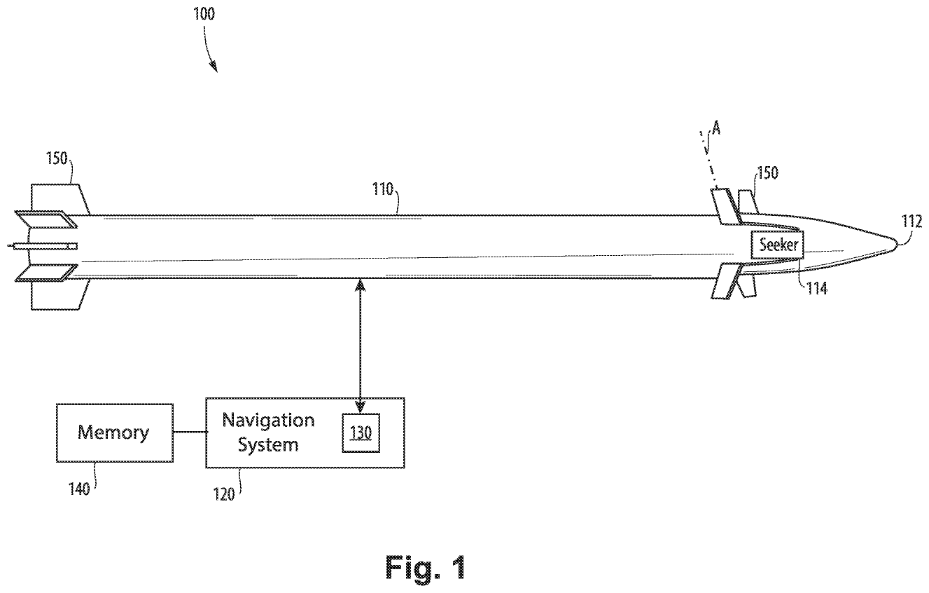

With reference now to FIG. 1, shown is an exemplary embodiment of a munition 100 that is a suitable exemplary environment in which certain embodiments of the below described illustrated embodiments may be implemented. FIG. 1 is an example of a suitable environment and is not intended to suggest any limitation as to the structure, scope of use, or functionality of an embodiment of the illustrated embodiments. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

For instance, the munition 100 shown in FIG. 1 is depicted as a projectile 110 (as described below). However, a munition of the illustrated embodiments described herein is not to be understood to be limited to projectile 110 as shown, as it may encompass any suitable munition including, but not limited to: gun launched munitions; rocket propelled munitions; motor propelled munitions; air dropped munitions and Unmanned Aerial Vehicles. It is to thus be appreciated for ease of illustration, munition 100 is shown and described as a projectile 110 in FIG. 1. In one or more embodiments, munition 100 is a node of a plurality of nodes travelling in a constellation, such as a plurality of aircraft, land or water bound vehicles or drones, robots, etc. Travel can include, for example flight, movement in water (above or below), earthbound movement.

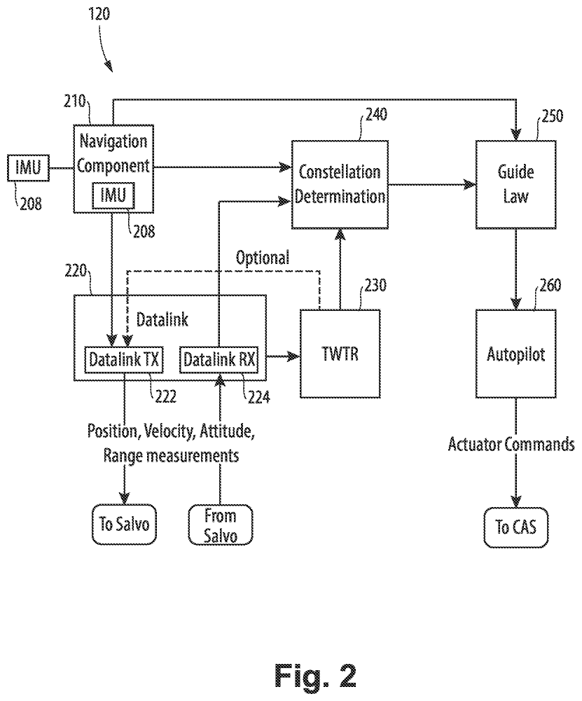

As shown in FIG. 1, munition 100 includes a navigation system 120 having at least one associated processor 130 operatively connected to a memory 140. Certain components of the navigation system 120 are described further below with reference to FIG. 2. It is to be appreciated and understood, the projectile 110 of FIG. 1 is configured and adapted to undertake the operations described below. For instance the projectile 110 may include a plurality of control surfaces 150, e.g., all-moving fins and fixed lifting surfaces with hinged control surfaces, configured to rotate about their respective deflection axes, e.g., axis A as shown, to generate control forces and moments. In one or more embodiments, a seeker 114 can be affixed to a nose portion 112 of projectile 110 and configured for recognizing a target.

Those skilled in the art will readily appreciate that navigation system 120 is disposed within projectile 110. Those skilled in the art will also readily appreciate that processor 130 may be any one of numerous known processors or an application specific processor that operates in response to program instructions. Processor 130 can comprise more than one distinct processing device, for example to handle different functions, e.g. different operations of the method described below. It is also contemplated that memory 140 can be any form of memory device, for example, volatile or non-volatile memory, solid state storage device, magnetic device, or the like. It will be appreciated that memory 140 may include either, or both, RAM (random access memory) and ROM (read only memory). It will be further appreciated that memory 140 could be integrally formed as part of processor 130.

In accordance with the certain illustrated embodiments, and with reference now to FIG. 2, navigation system 120 of a munition, such as munition 100 shown in FIG. 1, may include and/or be communicatively coupled to the components/software modules shown in FIG. 2, as now briefly described. Navigation system 120 includes a navigation component 210 for determining positioning of the munition while in flight. In particular, navigation component 210 is configured and operable such that a munition is able to estimate its position, velocity and attitude with covariance estimates using an Inertial Measurement Units (IMU) 208, as well as any other navigation aiding solutions provided on a particular munition type.

As readily understood by one of ordinary skill in the art, IMUs have been used in a wide variety of applications. For example, IMUs are commonly used in inertial guidance and navigation systems for all types of vehicles, in particular aircraft and spacecraft. Inertial navigation has the advantage of not being dependent on an external point of reference (e.g., GPS). Navigation is accomplished by sensing the motion of munition and calculating the change in position with respect to an initial position. IMU 208 is able to determine the three-dimensional orientation of munition 100 relative to a reference direction absolutely within an inertial system.

An example IMU may consist of three equal modules, each including a gyroscopic rotational rate sensor, a linear accelerometer, and associated electronics. Each module is typically oriented on a cube or a similar structure to provide inertial measurements along one of three orthogonal axes, with the gyroscopic rotational rate sensors providing information regarding rotation of the unit and the accelerometers providing information concerning linear movement of the unit. In this way, the IMU is able to determine the position of the vehicle with respect to the vehicle's initial position to aid in guidance, navigation, and control of the vehicle.

Three-axis inertial measurement units as described above have been used extensively in aerospace applications. Traditionally, such IMUs included mechanical sensors such as conventional spinning mass gyroscopes and large mechanical accelerometers. However, most current IMUs utilize microelectromechanical systems (MEMS) devices. Many MEMS sensors are mounted on a support substrate made of silicon or a similar material and can detect acceleration by measuring a change in capacitance. Current technologies using MEMS devices encapsulate the accelerometer, gyroscope, and associated electronics into individual packages. These packages are typically soldered to a circuit board, which is then mounted on one plane of an orthogonal assembly, such as a face of a cube.

Most inertial sensors, including MEMS sensors, are perpendicular sensors or out of plane devices, meaning that the sense axis of the device is oriented at a 90 degree angle with respect to the mounting plane. Some MEMS devices, including accelerometers and gyroscopes, are in-plane sensors. In-plane sensors are inertial sensors having a sense axis that is parallel to the mounting plane. In-plane sensors detect an acceleration or rotation along an axis parallel to the surface of the support substrate. Navigation component 210 can be configured to process the data from the IMU (also referred to as IMU data) to determine position, velocity, and attitude (also referred to as a navigation solution or navigation data) of the munition.

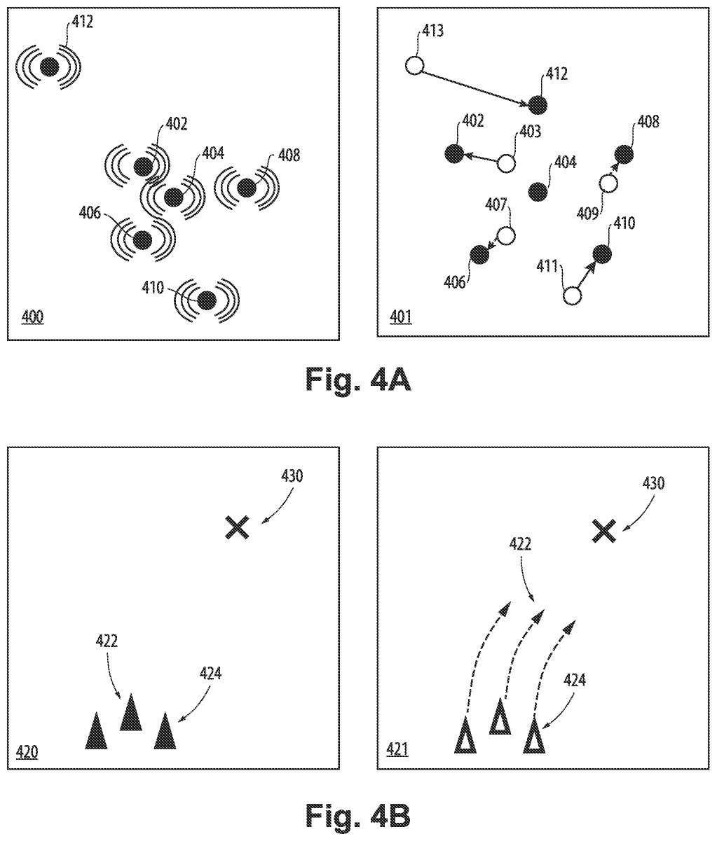

In accordance with the illustrated embodiments, navigation system 120 is provided with a datalink system 220 having a datalink transmitter 222 and a receiver 224 for providing direct two-way communication over a data link with other munitions in a traveling group of munitions (such as a salvo; see, for example munitions 402, 404, 406, 408, 410, 412 in salvo 400 shown in FIG. 4A), each of the other munitions also having a compatible datalink system 220.

While the example shown and described is a salvo of munitions, the disclosure is not limited to a salvo of munitions, but can refer to a group of nodes that travel together using a constellation that has a defined formation. As described further below, travel of a group of munitions, e.g., salvo 400 of munitions 402, 404, 406, 408, 410, 412 shown in FIG. 4A, can be executed in a constellation having a formation based on formation data that was preloaded for each of the munitions. The formations can be different shapes, such as honeycomb, checkerboard, rectangle, row/column, etc. The formation can have a flexible shape that merely requires a predefined distance between munitions.

Munitions within communication range with one another via their respective datalink systems 220 are enabled to communicate in real-time with each other so as to share and communicate navigation data (e.g., position coordinates, velocity, attitude and range measurements) with each other. In addition, Two-Way Timing and Ranging (TWTR) data as determined by a TWTR software module 230 provided in the navigation system 120 may be shared by the datalink system 220 of each of the munitions that are with communication range of one another.

TWTR module 230 of a munition is operable to estimate ranges between the munition (e.g., munition 402 of FIG. 4A) and other munitions in the same salvo (e.g., munitions 404-412 within salvo 400, FIG. 4A) based on data received via its datalink RX 224. Thus, in accordance with the illustrated embodiments it is to be appreciated that each munition is equipped with a TWTR module 230 that applies TWTR algorithms operable to estimate the range between itself and other munitions in its salvo and to share TWTR data via datalink system 220 to synchronize its clock signals with clock signals output by the other munitions.

Navigation system 120 of the munition further includes a constellation determination software module 240 which is operable to utilize the munitions navigation data from the IMU of the navigation component 210, in conjunction with data received via datalink RX 224 from other munitions in the same salvo. The data received from the other munitions in the salvo includes navigation solutions determined by navigation components 210 of the respective other munitions from the corresponding munition's IMU data and other aiding sensors, if available. In one or more embodiments, the data received from the other munitions can further include TWTR data determined by and provided from TWTR module 230 of the respective other munitions.

Constellation determination software module 210 of munition 402 is configured to determine an estimated position of the other munitions (404-412) in salvo 400 that are within communication range, and a distance range to them. This enables the navigation system 120 of the munition 352 to establish its position relative to other munitions 354-360 in the salvo. A constellation of the munitions can be first defined by the relative positions, e.g., in body frame coordinates, with the processing munition being at the origin. Each munition can have its own calculation of the constellation in its own body frame coordinates (which for a munition can be an x-axis that points out the nose, a y-axis that points out a right side of the fuselage, and a z-axis that points out a bottom of the fuselage.

The constellation can be resolved in a local navigation frame (such as North, East, Down coordinates) using the estimated attitude of the munition and the position estimates of the munitions that have been resolved in the local frame and received via the data link. The constellation can also be resolved in a global frame by taking estimated global positions (such as latitude, longitude, altitude) of the munition and resolving its local frame into the global frame (which can be done, for example, using rotation matrices).

Guide law module 250 is communicatively coupled to navigation component 210 for receiving navigation data and to constellation module 240 for receiving relative positions of the munition relative to the other munitions. Guide law module 250 further accesses pre-loaded formation constraints. The formation constraints are configured to maintain the shape of the constellation. The constraints can have varied complexity. Constraints with simple complexity can require that the munitions maintain a minimum distance from one another in order to avoid collision, but not exceed a maximum distance from all or a prescribed number of other munitions in the salvo, such as to preserve the ability to communicate via their respective data link systems 220. More complex constraints can require that the munitions maintain the preloaded formation, with each munition maintaining a particular range of distances between specified a particular munitions of the salvo. Guide law module 250 calculates theoretical spring forces applied to the munition for determining whether the constellation determined by the munition is in compliance with the formation constraints.

When the constellation is determined to not be in compliance with the formation constraints, navigational maneuvers are determined to maneuver the munition to change its position relative to the other munitions to cause the constellation to be in compliance with the formation constraints by adjusting the spring forces applied to the munition to optimally achieve equilibrium as defined by the formation constraints. Navigation aiding measurements are calculated for executing the maneuver. In addition, when the constellation is determined to not be in compliance with the formation constraints, guide law module 250 can ignore navigation data and TWTR data (if any) from munitions that are determined to be outliers or unreliable.

As an example, when munitions are too close to one another per the formation constraints, the munitions autonomously maneuver to push away from one another. When munitions are too far apart from one another per the formation constraints, the munitions each autonomously maneuver to pull towards one another. Munitions can maneuver based on the sum of the forces induced by theoretical spring forces of multiple other nodes of the salvo. Each munition can continue to autonomously maneuver until it reaches an equilibrium point where all formation constraints are met. As the munitions maneuver to maintain their flight path, they also need to maneuver to comply with the constraints.

As also further described below, the sharing of such navigation data and optionally sharing TWTR data amongst munitions in a salvo enables the navigation system 120 of each munition 100 to process the aforesaid shared navigation data in guide law module 250 for adjusting its position relative to the other munitions for optimizing spring forces on the munition in order to achieve equilibrium that is compliant with the formation constraints.

The determined navigational maneuvers for the munition are communicated from guide law module 250 as guidance commands to an autopilot component 260 operable to determine proper actuator commands for the munition to execute the maneuvers determined by guide law module 250. As shown, the determined actuator commands are sent to a control actuation system (CAS), which includes, for example control surfaces, motors, actuators, etc.

There are also opportunities for the munitions to carry different hardware. For example, one or more munitions of the salvo can be equipped with a GPS. The other munitions can operate without a GPS receiver and without using GPS data. Accordingly the salvo can operate with or without GPS, including in a GPS-denied environment. One or more of the munitions can be equipped with additional sensor(s), such as a magnetometer, altimeter, air data sensor, terrain matching imagers, etc. The output from any of the sensors can be used, for example, to determine the navigation solution, e.g., by using a Kalman filter or similar filter.

The autonomous capabilities of the munitions in the salvo provides for distributed control of the salvo. Reliance on a single, fallible node is avoided. There is no need to have an enhanced, and more expensive node to provided centralized control of the salvo. The data shared between nodes is simplified. Instead of a centralized node that collects position and ranging data from the other nodes and sends formation information and commands to the other nodes, the distributed munitions share position and ranging data and determine their own commands.

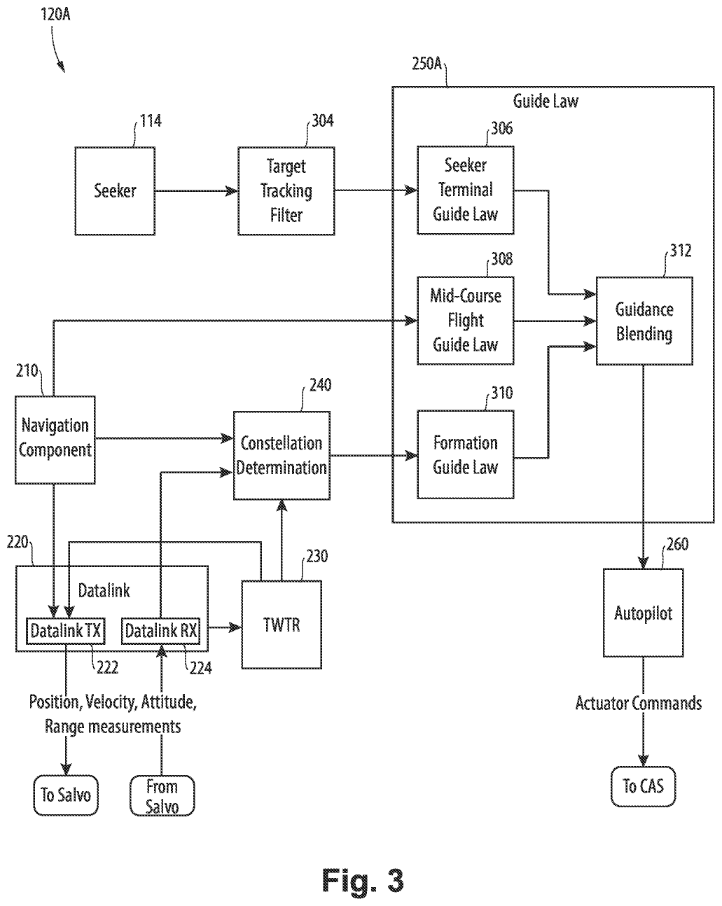

With reference to FIG. 3, a block diagram of a navigation system 120A is shown, wherein navigation system 120A communicates with a seeker 114 and target tracking filter 304 of the munition (e.g., munition 100 shown in FIG. 1). Components 210, 220, 222, 224, 230, and 240 are the same as shown and described with respect to FIG. 2. Target tracking filter 304 receives target location measurements from seeker 114 for targets recognized by seeker 114, and is configured to track the targets. Guide law module 250A is similar to guide law module 250 shown in FIG. 2 in that it outputs guidance commands to autopilot component 260, wherein autopilot component 260 outputs actuator commands for the munition to execute maneuvers determined by guide law module 250A.

Guide law module 250A includes a seeker terminal guide law module 306 and/or a mid-course flight guide law module 308 in addition to a flight formation guide law module 310. Seeker terminal guide law module 306 receives tracking output from target tracking filter 304, such as a target line-of-sight rate, and applies seeker guide laws to generate seeker guidance commands that can be used to generate actuator commands for executing maneuvers to collide with the target.

Mid-course, flight guide law module 308 receives navigation output from navigation component 210, such as position, velocity, and attitude, and applies mid-course guide laws to generate mid-course guidance commands that can be used to generate actuator commands for executing maneuvers to guide the munition along a pre-loaded flight path and make corrections mid-course to maintain the flight path. Flight formation guide law module 308, similar to guide law module 250 of FIG. 2, receives the constellation output from constellation determination module 240 and applies formation laws to generate formation guidance commands that can be used to generate actuator commands for executing maneuvers to guide the munition for adjusting the constellation to adjust spring forces applied to the munition to optimally achieve equilibrium as defined by preloaded formation constraints.

Guidance blending software module 312 receives the various guidance commands, including the seeker and/or mid-course guidance commands and the formation guidance commands, and combines these various guidance commands using combinatorial techniques. The combinatorial techniques can use command blending while ensuring the munition is guided to its target destination. The munition can use the command for the target destination from the mid-course guidance commands and apply additional corrections from the formation guidance commands as needed. Weights can be applied to the mid-course or formation guidance commands to optionally favor one over the other. The combined guidance commands are processed by guidance blending module 312 to output guidance commands to autopilot 260. Based on the guidance commands, autopilot 260 outputs actuator commands to the CAS.

With reference to FIGS. 4A and 4B, in scene 400, munitions 402, 404, 406, 408, 410, 412 in a salvo 400 share their position coordinates, velocity, attitude and range measurements, navigation solutions, and optionally TWTR range measurements using a data link.

In scene 401, munitions 402, 404, 406, 408, 410, 412 move from their original positions 401, 403, 405, 407, 408, 411, and 413, respectively, into new positions that satisfy rules based on the preloaded formation and that satisfy the formation constraints. The formation constraints exert theoretical spring forces on munitions 402, 404, 406, 408, 410, 412 that cause the munitions 402, 404, 406, 408, 410, 412 to maneuver into their new positions.

At scene 420, a salvo 422 of munitions is positioned at first positions 424 along a flight path 426. Scene 421 illustrates that as salvo 420 moves along flight path 426, e.g., toward a target location 430, the munitions of salvo 422 optimize their maneuvers to stay along flight path 426 and comply with the formation constraints.

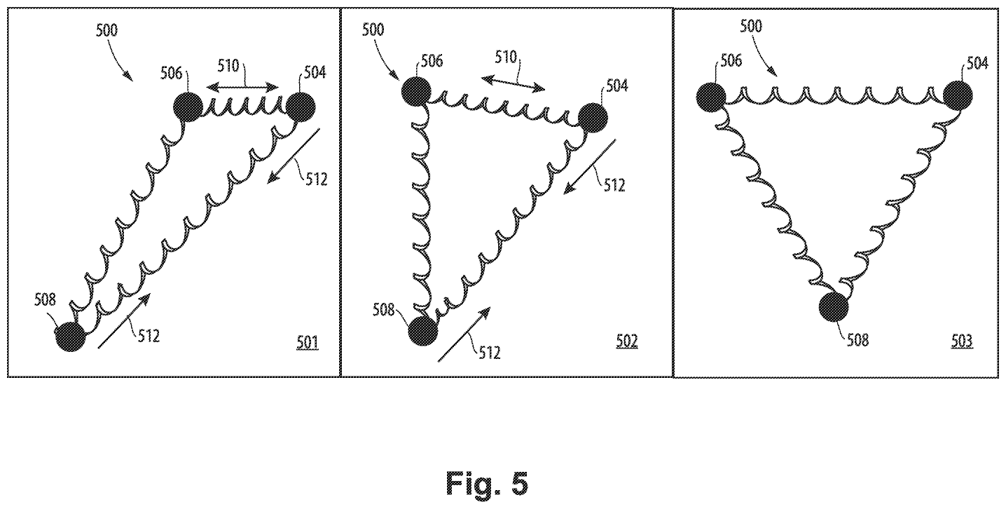

With reference to FIG. 5, a salvo of munitions 500 is shown having three munitions, 504, 506, 508. At scene 501, munitions 504 and 506 are too close based on the formation constraints, hence a theoretical spring force illustrated by arrow 510 pushes the munitions 504 and 506 away from each other. Munitions 504 and 508 are too far apart based on the formation constraints, hence a theoretical spring force illustrated by arrows 512 pulls the munitions 504 and 506 towards one another. The distance between munitions 506 and 508 satisfies the formation constraints, hence there is no interaction between munitions 506 and 508 to push apart or pull together. At scene 502, two or more of munitions 504, 506, 508 move their positions relative to the other munitions of salvo 500, each munition moving based on the sum of forces 510 and 512 acting it. At scene 503, two or more of munitions 504, 506, 508 continue to move their positions relative to the other munitions of salvo 500 until all constraints are med and equilibrium is met.

Accordingly, by constraining the theoretical spring forces the munitions of salvo 500, based on the formation constraints, each guide themselves independently and autonomously in a way that the salvo of munitions are guided together as they travel. The guidance is based on IMU data and TWTR data, but does not use GPS information and can be performed in a GPS-free environment or with munitions that are not capable of sensing GPS. GPS may be used if available, but this invention can work in GPS denied environments. The invention can use GPS information, but does not require it. Without such formation constraints, a munition that were to guide itself independently without using GPS data may drift away from the other munitions of its salvo due to IMU data biases and lose communication via its data link system. Since the munitions of salvo 500 can remain in range of the other and can thus continue to communicate throughout the flight, the munitions have opportunities to provide navigation aide to one another during the flight.

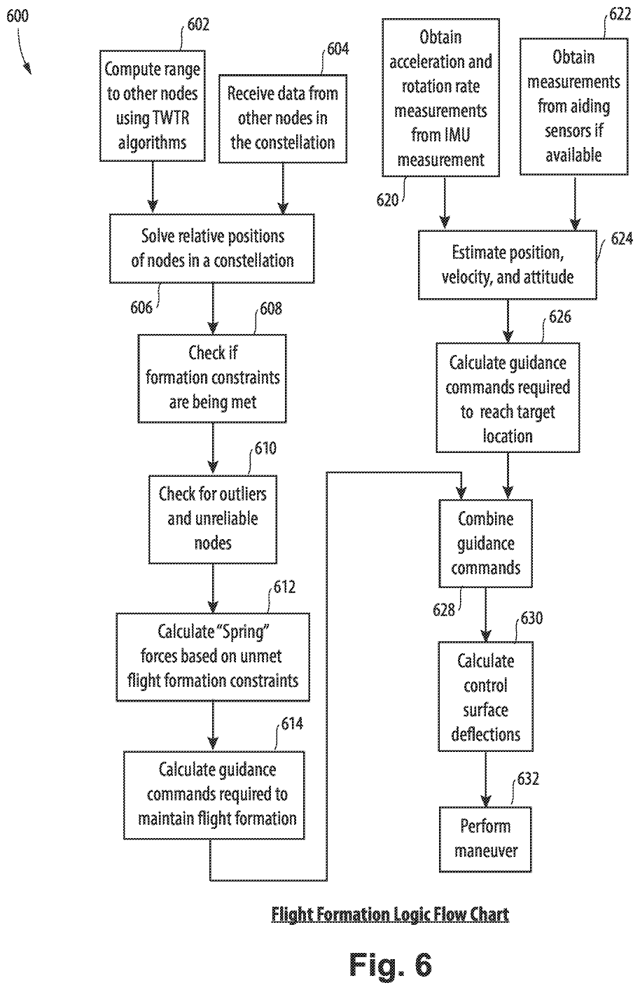

With reference to FIG. 6, an exemplary and non-limiting flowchart 600 illustrates a method performed autonomously by a navigation system of each node in a traveling group of nodes, such as navigation system 120 shown in FIGS. 2 and 3 in accordance with certain illustrated embodiments. The method can be performed by a navigation system of each node in a traveling group, such as navigation system 120 shown in FIGS. 2 and 3.

Before turning to description of FIG. 6, it is noted that the flowchart in FIG. 6 shows an example in which operational steps are carried out in a particular order, as indicated by the lines connecting the blocks, but the various steps shown in this diagram can be performed in a different order, or in a different combination or sub-combination. It should be appreciated that in some embodiments some of the steps described below may be combined into a single step. In some embodiments, one or more additional steps may be included. In some embodiments, one or more of the steps can be omitted.

At block 602, ranges to other nodes of the group of traveling nodes is computed. TWTR algorithms can be applied to data received from the other nodes in order to generate TWTR data that can be used to compute the ranges to the other nodes. If GPS is available, the position estimates could alternatively be used to find accurate ranges. Without GPS, using the difference in estimated position is unreliable as the position estimate will drift due to IMU errors. At block 604, navigation data is received from other nodes. The output of blocks 602 and 604 is received at block 606 and is used to solve relative positions of the nodes in a constellation.

At block 608, it is determined whether preloaded formation constraints are met by the relative positions. At block 610, nodes that are outliers or unreliable are disregarded. Block 610 may be performed on condition that the formation constraints are not met or before performance of block 608. At block 612, theoretical spring forces on the node due to unmet formation constraints are calculated. Block 612 may be performed on condition that the formation constraints are not met. At block 614, formation guidance commands are calculated for maintaining the formation and satisfying the formation constraints.

One or more of blocks 602-614 can be performed in parallel and/or simultaneously with blocks 620-626. At block 620, IMU data is obtained from sensors of an IMU At block 622 measurements from additional sensors can be obtained, wherein these measurements may be helpful for estimating navigation data. An example of an additional sensor is a GPS sensor.

The various nodes can be equipped with different sensors. The advantages gained by one of the nodes having data from an additional sensor can aid the other nodes. The more highly equipped nodes can function as an anchor or reference point for the other nodes or can share its data via the nodes' respective data link systems, such as data link systems 120 shown in FIGS. 2 and 3. For example, since there are also opportunities for the nodes to carry different hardware, one node may be equipped, for example with a GPS and be a focal point of the constellation. The other nodes, without a GPS receiver and without using GPS data, are able to guide themselves autonomously relative to the node at the focal point.

At block 624, navigation data is determined based on the IMU data and optionally measurements from the additional sensors. At block 626, flight path guidance commands are determined for maintaining a flight path, such as towards a target that is being tracked based on output from a seeker. At block 628 the formation guidance commands and the flight path guidance commands are combined. At block 630, deflections of control surfaces are calculated and actuator commands are output. At block 632, the actuator commands are applied for performing a maneuver to continue on the flight plan in accordance with the preloaded formation and formation constraints.

In accordance with the above description, potential benefits include 1) coordination of flight paths of multiple nodes to avoid collisions or other interference that could cause loss of a node; 2) a mechanism to keep nodes positioned so that they maintain an ability to communicate with other nodes of their traveling group of nodes via their respective datalink systems; 3) nodes in the group of traveling nodes can be equipped differently, and each node can still independently and autonomously guide itself to a target location; 4) control of the group of nodes is distributed, avoiding the disadvantages of centralized control.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this disclosure, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A method for coordination of a plurality of nodes for travelling in a constellation mission, wherein each node is provided with a datalink communication system to communicate with other nodes, the method comprising:
obtaining at each node navigation data of the node;
communicating at each node the navigation data of the node to the other nodes of the plurality of nodes via each node's datalink communication system;
receiving at each node navigation data communicated from the other nodes via each node's datalink communication system;
determining at each node distance range of the node relative to the other nodes for which navigation data was received;
determining at each node a constellation of the plurality of nodes as a function of the navigation data of the node, the navigation data received from the other nodes, and the distance range of the node relative to the other nodes;
accessing formation constraints at each node, wherein the formation constraints are configured to form the constellation;
calculating at each node first guidance commands to maneuver the node to adjust the constellation determined by the node to be in compliance with the formation constraints; and
navigating each node to execute a maneuver based on the first guidance commands.

2. The method of claim 1, further comprising:
calculating at each node spring forces applied to the node; and
determining whether the constellation determined by the node is in compliance with the formation constraints, wherein the constellation is caused to be in compliance with the formation constraints by optimizing the spring forces applied to the node to be at equilibrium.

3. The method of claim 1, further comprising:
calculating at each node second guidance commands to maneuver the node along a flight path based on a predetermined flight plan or target destination and the navigation data of the node; and
combining the first and second guidance commands, wherein navigating the node is based on the combination of the first and second guidance commands.

4. The method of claim 1, further comprising:
tracking a target at each node;
calculating at the node second guidance commands to maneuver the node along a fight path to a target based on the tracking; and
combining the first and second guidance commands, wherein navigating the node is based on the combination of the first and second guidance commands.

5. The method of claim 1, wherein the plurality of nodes are a plurality of munitions in a salvo discharged to attack one or more targets.

6. The method of claim 1, wherein one or more of the nodes are denied access to a Global Positioning System (GPS).

7. The method of claim 1, further comprising:
receiving at each node inertial measurement data; and
estimating at each node the navigation data for the node from the inertial measurement data received at the node, wherein the navigation data includes position, velocity, and attitude.

8. The method of claim 1, wherein each node is preloaded with at least one of a flight plan to a target destination, the formation constraints, and a formation of the constellation.

9. The method of claim 5, wherein each munition in the salvo is selected from the group consisting of: gun launched munitions; rocket propelled munitions; motor propelled munitions; air dropped munitions; and Unmanned Aerial Vehicles.

10. The method of claim 1, further comprising, when the constellation is determined by the node to not be in compliance with the formation constraints, ignoring nodes that are determined to be outliers or unreliable.

11. A navigation system for providing coordination of a plurality of nodes for travelling in a constellation mission, the navigation system of each node comprising:
a datalink communication system configured and operable to communicate with other nodes of the plurality of nodes;
a navigation component for navigating the node in travel, wherein the navigation system is communicatively coupled to the datalink communication system;
a memory configured to store instructions;
a processor disposed in communication with the memory, wherein the processor upon execution of the instructions is configured to:
obtain navigation data of the node;
communicate the navigation data of the node to the other nodes of the plurality of nodes via each node's datalink communication system;
receive navigation data communicated from the other nodes via each node's datalink communication system;
determine a distance range of the node relative to the other nodes for which navigation data was received;
determine a constellation of the plurality of nodes as a function of the navigation data of the node, the navigation data received from the other nodes, and the distance range of the node relative to the other nodes;
access formation constraints, wherein the formation constraints are configured to form the constellation;
calculate first guidance commands to maneuver the node to adjust the constellation determined by the node to be in compliance with the formation constraints; and
navigate the node to execute a maneuver based on the first guidance commands.

12. The navigation system of claim 11, wherein the processor upon execution of the instructions is further configured to:
calculate spring forces applied to the node; and
determine whether the constellation determined by the node is in compliance with the formation constraints, wherein the constellation is caused to be in compliance with the formation constraints by optimizing the spring forces applied to the node to be at equilibrium.

13. The navigation system of claim 11, wherein the processor upon execution of the instructions is further configured to:
calculate second guidance commands to maneuver the node along a flight path based on a predetermined flight plan or target destination and the navigation data of the node; and
combine the first and second guidance commands, wherein navigating the node is based on the combination of the first and second guidance commands.

14. The navigation system of claim 11, wherein the processor upon execution of the instructions is further configured to:
track a target;
calculate at the node second guidance commands to maneuver the node along a fight path to a target based on the tracking; and
combine the first and second guidance commands, wherein navigating the node is based on the combination of the first and second guidance commands.

15. The navigation system of claim 11, wherein the plurality of nodes are a plurality of munitions in a salvo discharged to attack one or more targets.

16. The navigation system of claim 11, wherein one or more of the nodes are denied access to a Global Positioning System (GPS).

17. The navigation system of claim 11, wherein the navigation data includes position, velocity, and attitude, which are estimated from inertial measurement data of the node and of the other nodes.

18. The navigation system of claim 11, wherein the memory is preloaded with at least one of a flight plan to a target destination, the formation constraints, and a formation of the constellation.

19. The navigation system of claim 15, wherein each munition in the salvo is selected from the group consisting of: gun launched munitions; rocket propelled munitions; motor propelled munitions; air dropped munitions; and Unmanned Aerial Vehicles.

20. The navigation system of claim 11, wherein the processor upon execution of the instructions is further configured to, when the constellation is determined by the node to not be in compliance with the formation constraints, ignore nodes that are determined to be outliers or unreliable.
